(19) United States
(12) Patent Application Publication
(10) Pub. No.: US 2025/0356328 A1
(43) Pub. Date: Nov. 20, 2025

(54) SYSTEMS AND METHODS FOR EXECUTING CROSS-NETWORK OPERATIONS

(71) Applicant: MASTERCARD INTERNATIONAL INCORPORATED, Purchase, NY (US)

(72) Inventors: Peter Groarke, Dublin (IE); Cathy Mignolet, Wavre (BE)

(21) Appl. No.: 18/667,850

(22) Filed: May 17, 2024

(51) Int. Cl. G06Q 20/08; G06Q 20/38; G06Q 30/08

(52) U.S. Cl. CPC G06Q 20/0855; G06Q 20/389; G06Q 30/08

(57) ABSTRACT

An instream transaction services computer system for executing cross-network operations is provided. The computer system is configured to generate an operation request message based on an identified off-network marketplace provider and an enrichment operation to be applied to a payment transaction message, transmit at least a portion of the operation request message to the identified off-network marketplace provider, receive an operation result, and transmit a response message with the operation result to a requestor.

### BACKGROUND

The field of the disclosure relates generally to systems and methods for cross-network processing of electronic data and, more particularly, to systems and methods for executing cross-network operations on electronic computer messages that originate on a home network, are partially processed on the home network, are directed to an off-network for additional processing, and are returned to the home network to complete the processing, wherein the off-network provides additional operational services to the messages.

In today's world, data is processed over many different computer networks. Data from one network may be sent to or retrieved by another computer network for further processing of that data. There are many challenges with sharing data among different computer networks, particularly when that data is confidential and/or includes personally identifiable information (PII). In these cases, the data oftentimes has to be protected in some way when sharing it over the different networks to minimize the risk of a data breach. Sometimes the data may be encrypted when sharing among different networks or protected in some other way. Other challenges of sharing data between networks may involve the format of the data. Data being processed over one network may include a specific format or messaging protocol that is not easily recognized by another network. Therefore, the other network may not be able to process that specifically formatted data without translating it into another format. Another challenge for data originating on a home network may be which other network the data should be sent to for the further processing. Decisions on where to direct the data may be challenging.

For example, financial data, payment data and/or medical data could all include PII data that needs to be protected. In one embodiment, a home computer network may include a payment processing network that processes payment transactions between a cardholder or an accountholder and a merchant by transmitting data messages between the merchant, the cardholder, and registered banks including issuer banks and/or acquirer banks. This registered relationship and the dedicated network enables secure and efficient authorization, clearing and settlement processes to occur between the parties. However, the parties to the transactions being processed by the home network may request additional payment services, sometimes known as transaction enrichment services, in conjunction with the transactions being performed over the home network.

These services may include, for example, data enrichment, transaction notification, fraud chargeback liability, settlement guarantee, or loyalty benefits provided by a known party within the network (e.g., the issuer, the acquirer, and/or the merchant). However, under these known systems, only some of these services may be available and may only be provided by parties in this “home” payment network due to data security concerns, data formatting challenges, and an inability to easily direct these messages outside of the payment network. In other words, only a limited number of enrichment services can be provided to a party to the transaction and the enrichment services can only be applied to the transaction messages that originate and are processed over the same established payment network for parties within the payment network offering the services. This network-based limitation also limits the types of services that can be offered over the originating network.

It may be desirable to offer broader and different message processing operations that can be seamlessly provided by off-network third parties, outside of the “home” payment network, for transactions originating on the “home” payment network.

### BRIEF DESCRIPTION

In one aspect, an instream transaction services computer system is provided. The instream transaction services computer system includes a memory and at least one processor in communication with the memory. The memory stores instructions executable to cause the at least one processor to receive a payment transaction message including one or more identifiers and query a marketplace registration database using the one or more identifiers contained in the payment transaction message to retrieve a registration record. The registration record includes an identification of at least one of a marketplace provider and an enrichment operation. The memory storing instructions executable to cause the at least one processor to generate an operation request message based on the identified at least one marketplace provider and the enrichment operation and transmit at least a portion of the operation request message to the identified marketplace provider and in response to the transmission, receive an operation result message from the identified marketplace provider including an output result of the enrichment operation being applied to the payment transaction message. The memory storing instructions executable to cause the at least one processor to transmit, to a requestor computer system, a response message indicating the output result of the enrichment operation being applied to the payment transaction message.

In yet another aspect, a computer-implemented method using an instream transaction services computer system having a memory and at least one processor in communication with the memory and with a plurality of services platforms is provided. The computer-implemented method includes receiving a payment transaction message including one or more identifiers and querying a registration database using the one or more identifiers contained in the payment transaction message to retrieve a registration record. The registration record includes an identification of at least one of a marketplace provider and an enrichment operation. The method includes generating an operation request message based on the identified at least one marketplace provider and enrichment operation and transmitting at least a portion of the operation request message to the identified marketplace provider. The method includes, in response to transmitting, receiving an operation result message from the identified marketplace provider including an output result of the enrichment operation being applied to the payment transaction message and transmitting, to a requestor computer system, a response message indicating the output result of the enrichment operation being applied to the payment transaction message.

In yet another aspect, at least one non-transitory computer-readable storage medium that includes computer-executable instructions embodied thereon that when the computer-executable instructions are executed by at least one processor of a marketplace operation computer is provided. The computer-executable instructions cause the at least one processor to receive a payment transaction message including one or more identifiers and query a marketplace registration database using the one or more identifiers contained in the payment transaction message to retrieve a registration record. The registration record includes an identification of at least one of a marketplace provider and an enrichment operation. The computer-executable instructions cause the at least one processor to generate an operation request message based on the identified at least one marketplace provider and the enrichment operation and transmit at least a portion of the operation request message to the identified marketplace provider and in response to the transmission, receive an operation result message from the identified marketplace provider including an output result of the enrichment operation being applied to the payment transaction message. The computer-executable instructions cause the at least one processor to transmit, to a requestor computer system, a response message indicating the output result of the enrichment operation being applied to the payment transaction message.

### BRIEF DESCRIPTION OF THE DRAWINGS

FIG. 1 is a schematic diagram illustrating an example multi-party payment card industry system for enabling payment transactions in which merchants and card issuers do not necessarily have a one-to-one relationship.

FIG. 2 is a block diagram showing a payment processing environment, including an off-network marketplace, in accordance with one embodiment of the present disclosure.

FIG. 3 is a data flow diagram for off-network marketplace providers to apply marketplace operations to a payment transaction.

FIG. 4 is a simplified block diagram of an example computer system representative of the instream transaction services computer system in the payment processing environment, shown in FIG. 2.

FIG. 5 illustrates an example configuration of a cardholder computer system operated by a cardholder shown in FIGS. 1 and 2.

FIG. 6 illustrates an example configuration of the server computer system shown in FIGS. 1 and 2.

FIG. 7 is a flow diagram of an example method of implementing marketplace operations to an authorization process, which may be implemented by the computer system shown in FIG. 6.

FIG. 8 is a flow diagram of an example method for providing multiple channels to requestors for access to at least one off-network marketplace, which may be implemented by the computer system shown in FIG. 6.

### DETAILED DESCRIPTION OF THE DISCLOSURE

The following detailed description illustrates embodiments of the disclosure by way of example and not by way of limitation. It is contemplated that the systems and processes described herein have general application to the aspect of processing payment card transactions. More specifically, the embodiments of the systems and methods described herein relate generally to payment transactions that are initiated over a home payment network and a newly added instream transaction services (ITS) computer system that is associated with an off-network ecosystem that provides additional enrichment services, wherein the ITS computer system is configured to receive a request from a requestor to apply an off-network enrichment operation (sometimes referred to as a marketplace operation) to the transaction message, apply the off-network enrichment operation to the transaction, and transmit an output to the requestor. Because this transaction is initiated on the home payment network and processed by the ITS computer system associated with the off-network ecosystem/marketplace, the transaction message may be referred to as an off-network or cross-network transaction message.

Described in detail herein are example embodiments of systems and methods for applying off-network marketplace operations to a home payment network payment transaction. The systems and methods facilitate, for example, applying off-network marketplace operations such as, and without limitation, data enrichment, transaction notification, fraud chargeback liability, settlement guarantee, or loyalty benefits to a home payment network payment transaction. Other enrichment services may also be provided with the ITS computer system in place. The systems and methods described herein include an instream transaction services (ITS) computer system configured to receive a request associated with a payment transaction from a home payment network at an off-network marketplace and apply the marketplace operations, if applicable, to the payment transaction, and transmit an output to the home payment network.

At least one of the technical problems addressed by the systems and methods include: i) limited number of in-network parties enabled to provide enrichment operations to a transaction request message; ii) limited number of available enrichment operations, provided by an in-network party, that may be applied to a transaction request message; iii) in-ability to communicate, e.g., request a enrichment operation, with off-network parties outside of the in-network parties; iv) in-ability to accept and/or apply a enrichment operation to a transaction request provided by an off-network party; v) limited number of participants in a marketplace for providing enrichment operations to transaction request messages; vi) inability to accept a bid for a enrichment operation from off-network parties, and/or iv) unknown credibility of off-network parties preventing in-network parties from interacting, e.g., request and/or accept enrichment operations, with unvetted off-network parties.

The resulting technical effect achieved by the systems and methods described herein is at least one of: i) expanding the number of parties enabled to provide an enrichment operation to a transaction request message; ii) expanding the number of parties enabled to bid on a enrichment operation to be applied to a transaction request message; iii) enabling communication between in-network parties and off-network parties; iv) vetting and approving off-network parties to ensure security of transaction request messages and/or enrichment operations applied to transaction request messages; v) enabling application of an enrichment operation provided by an off-network party to be applied to a transaction request message originating between in-network parties.

The methods and systems described herein may be implemented using computer programming or engineering techniques including computer software, firmware, hardware or any combination or subset thereof, wherein the technical effect may be achieved by performing at least one of the following steps: i) receive a payment transaction message including one or more identifiers; ii) query a marketplace registration database using the one or more identifiers contained in the payment transaction message to retrieve a registration record, wherein the registration record includes an identification of at least one of a marketplace provider and an enrichment operation; iii) generate an operation request message based on the identified at least one marketplace provider and the enrichment operation; iv) transmit at least a portion of the operation request message to the identified marketplace provider; v) in response to the transmission, receive an operation result message from the identified marketplace provider including an output result of the enrichment operation being applied to the payment transaction message; vi) transmit, to a requestor computer system, a response message indicating the output result of the enrichment operation being applied to the payment transaction message; vii) transmit the operation request message via a gateway for an application programming interface (API), the API defining a plurality of parameters corresponding to a plurality of data fields of a communications standard for exchange of financial transaction data between financial institutions; viii) generate the operation request message based on the identified at least one marketplace provider and enrichment operation, wherein the operation request message is formatted according to a communications standard for exchange of financial transaction data between financial institutions, the communications standard defining a plurality of data fields to be included within messages compliant with the communications standard, and wherein the operation request message is configured to cause a computing device associated with the marketplace provider to execute the enrichment operation on the transaction data; ix) receive an initiating operation request message from the requestor; x) translate the initiating operation request message to generate the operation request message; xi) generate one or more marketplace registration records registering requestors for at least one of an enrichment operation and marketplace provider, wherein the marketplace registration record includes one or more identifiers including at least one of an account identifier, a requestor identifier, or a marketplace identifier; and/or xii) generate one or more marketplace registration records registering requestors for at least one of an enrichment operation and marketplace provider, wherein the marketplace registration record includes one or more identifiers including at least one of an account identifier, a requestor identifier, or a marketplace identifier.

As used herein, an acquiring bank or acquirer is typically a bank (or financial institution) at which a merchant holds an account. Further, an issuing bank or issuer (or financial institution) is typically a bank at which a customer or cardholder holds an account. The account may be debited or charged through the use of a debit card, a credit card, or another type of payment card or a payment account as described herein.

As used herein, the terms “payment card,” “financial transaction card,” and “transaction card” refer to any suitable payment card, such as a credit card, a debit card, a prepaid card, a charge card, a membership card, a promotional card, a frequent flyer card, an identification card, a gift card, and/or any other device that may hold payment account data (e.g., bank account number, account identifier, primary account number, and/or any other data used to identify an account), such as mobile phones, smartphones, smart cards, digital wallets, personal digital assistants (PDAs), key fobs, and/or computers. Each type of payment card can be used as a method of payment for performing a transaction. In addition, cardholder account behavior can include but is not limited to purchases, management activities (e.g., balance checking), bill payments, achievement of targets (meeting account balance goals, paying bills on time), and/or product registrations (e.g., mobile application downloads).

As used herein, the term “home payment network” and related terms (e.g., “home network”) refers to a first payment processing network where a cardholder initiates a payment card transaction with a merchant. Entities within the home payment network may include the cardholder, the issuer, the acquirer, the merchant and/or a home payment processor. Any of the in-network entities may register for marketplace enrichment operations, as described in detail herein, provided by one or more off-network marketplace providers that are separate and distinct from any of the in-network entities included in the home payment network.

As used herein, the term “off-network parties” or “third parties” and related terms (e.g., “off-network”) may refer to a party that is outside of or separate from a home payment network that provides enrichment operations outside of the home network or that is different from in-network entities of the home payment network where the payment card transaction is originated. As used herein, off-network third party marketplace or ecosystem providers are capable of receiving marketplace operation requests from one or more home entities within the home payment network and providing and/or applying marketplace enrichment operations for payment card transactions originating in the home payment network by home entities who registered for the marketplace operations. For example, the ITS system may transmit payment transaction data and/or a marketplace enrichment operation request, associated with the payment card transaction, to a marketplace provider. The marketplace provider may apply the marketplace enrichment operation(s) to the payment transaction. The term applying, as it relates to a marketplace operation, is a term generally describing execution of the marketplace operation (execution of computer implemented instructions) or execution of further enrichment processing of the transaction message that provides additional value-added services to the requestor and/or the cardholder. For example, applying a marketplace operation may refer to enriching data contained within the payment transaction, such as adding additional data to the transaction message. In another example, applying a marketplace operation may refer to providing insurance coverage for an amount (full or partial) of the payment transaction in the event that the payment transaction is later determined to be fraudulent or if for some reason the merchant is unable to provide the product or service purchased. In some embodiments, the off-network marketplace providers are not necessarily financial institutions, but rather, can be any type of entity providing a value-added service. The off-network marketplace providers may include, without limitation, a sales tax compliance institution, a duty tax compliance institution, a fintech institution, a receipt institution, a loyalty installment institution, a fraud detection institution, an insurance provider, or any suitable entity enabled to provide a marketplace operation to a payment transaction.

As used herein, the term “translation module” and related terms (e.g., “translation module system”) refers to a method or system for converting marketplace operation requests from a format used on the home payment network (e.g., by an issuer bank, an acquiring bank, and/or the merchant) to a format that may be read or processed by the off-network marketplace providers and vice versa. The translation module may include, without limitation, a data layout protocol, an algorithm for mapping service requests from the home payment network format to the marketplace provider format and vice versa, and an automated program that converts marketplace (referred to herein as initiating service request) service requests from the home payment network format to the marketplace provider format and vice versa. For example, a payment transaction, initiated on the home payment network may be transmitted in an ISO® 8583 compliant data message or ISO® 20022 compliant message. As used herein, “ISO®” refers to a series of standards approved by the International Organization for Standardization. (ISO is a registered trademark of the International Organization for Standardization of Geneva, Switzerland.) ISO® 8583 compliant messages are defined by the ISO® 8583 standard which governs financial transaction card originated messages and further defines acceptable message types, data elements, and code values associated with such financial transaction card originated messages. ISO® 8583 compliant messages include a plurality of specified locations or data fields for storing Private Data Elements. The translation module may reconfigure the ISO® 8583 compliant messages associated with a payment transaction initiated on the home payment network to the request message having a format acceptable and readable by parties not on the home payment network.

As used herein, the term “network processor” or “payment processor” and related terms (e.g., “home network processor”) refers to computer system(s) associated with a payment network that may be used to communicate data between computer systems associated with an issuer bank, a cardholder, a merchant, an acquirer bank, a payment aggregator, a payment gateway, a government, a financial technology (“Fintech”) system, and/or an account clearing house (“ACH”) system, and communicate with off-network computer system(s) that may be used to provide marketplace operations. Also, as used herein, the home network processor may be configured to receive marketplace operation requests from a requestor and send marketplace operation requests to the translation module or directly to the off-network marketplace or marketplace providers.

As used herein, the requestor is the person or entity within the home payment network that is requesting, or has registered, for the marketplace operation to be applied to a payment transaction. The requestor may sometimes be referred to as the marketplace operation recipient or an authorizing entity who authorizes the marketplace operation (e.g., the entity paying for the marketplace operation or on whose behalf the marketplace operation is being carried out). The requestor may be the creator and sender of a marketplace operation request based upon marketplace registration record or a payment transaction. Thus, the requestor may be at least one entity within the home network (e.g., the issuer, the merchant, the acquirer, or the cardholder who registers with the marketplace operation and receives the marketplace operation). The requestor may generate a first service request and use either the requestor computer system translation module or the receiving ITS computer system translation module to translate or convert it to a second service request. Alternatively, another party within the home network, other than the requestor, may utilize the translation module to generate the service request, on behalf of the requestor. For example, the home payment network may generate the first service request and use either the requestor computer system translation module or the receiving ITS computer system translation module to translate or convert it to a second service request, on behalf of the requestor.

As used herein, a processor includes a programmable system including systems using microcontrollers, reduced instruction set circuits (RISC), application specific integrated circuits (ASICs), logic circuits, and any other circuit or processor capable of executing the functions described herein. The above examples are example only, and thus are not intended to limit the definition and/or meaning of the term “processor” in any way.

In one embodiment, computer-executable instructions are provided and are embodied on a non-transitory computer readable storage medium. The computer-executable instructions cause a computer executing the instructions to utilize a Structured Query Language (SQL) with a client user interface front-end for administration and a web interface for standard user inputs and reports. In an example embodiment, the system is web-enabled and is run on a business entity intranet. In an alternative embodiment, the system is fully accessible by individuals having authorized access from outside a firewall of the business-entity through the Internet. In a further alternative embodiment, the system is run in a Windows® environment (Windows is a registered trademark of Microsoft Corporation, Redmond, Wash.). The application is flexible and designed to run in various different environments without compromising any major functionality.

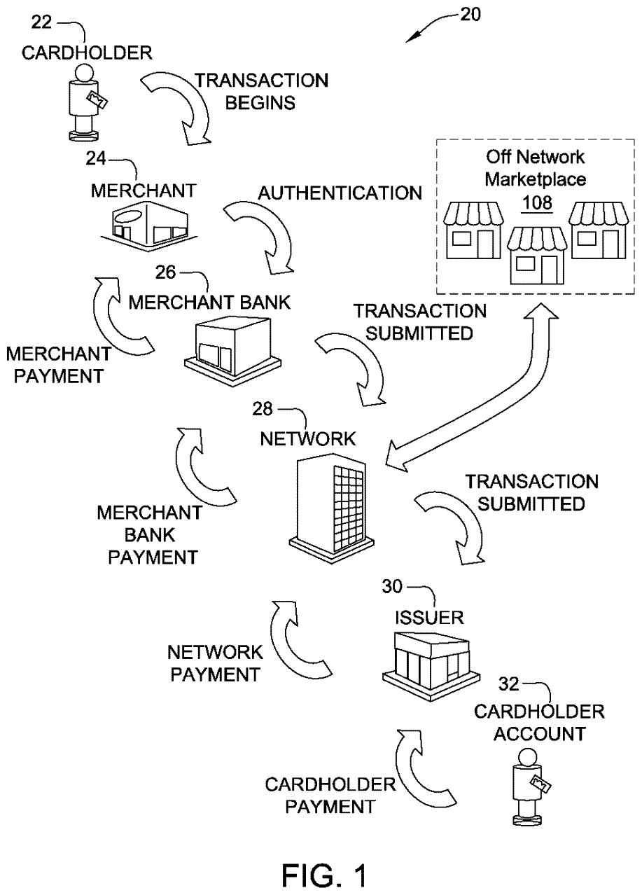

FIG. 1 is a schematic diagram illustrating an example in-network multi-party payment processing network system 20 for enabling payment transactions in which merchants 24 and card issuers 30 do not necessarily have a direct, one-to-one interaction. Processing network system 20 (sometimes referred to as the home network) includes an off-network marketplace system 108 (sometimes referred to as the off-network or secondary network) that, as described herein, is configured to be called upon by network system 20 to provide additional processing of payment transaction messages, provide enrichment services to the payment transaction messages, and transmit the enriched payment transaction messages back to network system 20. Embodiments described herein may relate to a payment card system, such as a credit card payment processing system using the Mastercard® interchange network (Mastercard is a registered trademark of Mastercard International Incorporated located in Purchase, New York). The Mastercard interchange network is a set of proprietary communications standards promulgated by Mastercard International Incorporated for the exchange of financial transaction data and the settlement of funds between financial institutions that are members of Mastercard International Incorporated.

In a typical payment card system, a financial institution called the “issuer” issues a payment card, such as a credit or debit card, to a consumer or cardholder 22, who uses the payment card to tender payment for a purchase from a merchant 24. To accept payment with the payment card, merchant 24 must normally establish an account with a financial institution that is part of the financial payment system. This financial institution is usually called the “merchant bank,” the “acquiring bank,” or the “acquirer,” such as a merchant bank 26. When cardholder 22 tenders' payment for a purchase with a payment card, merchant 24 sends an authorization request message to merchant bank 26 for the amount of the purchase. The request may be performed over the telephone, but may be also performed through the use of a computer system having access to a website or app enabling input of cardholder's 22 account information, or the use of a point-of-sale device, which reads cardholder's 22 account data from a magnetic stripe, a chip, or embossed characters on the payment card and communicates electronically with the transaction processing computers of merchant bank 26. Alternatively, merchant bank 26 may authorize a third party to perform transaction processing on its behalf. In this case, the point-of-sale device will be configured to communicate with the other party. Such other party is usually called a “merchant processor,” an “acquiring processor,” or a “third party processor.”

Issuer 30 may determine whether cardholder's 22 account 32 is in good standing and whether the purchase is covered by cardholder's 22 available credit limit. Based on these determinations, the request for authorization will be declined or accepted. When the request is accepted, an authorization code is issued to merchant 24.

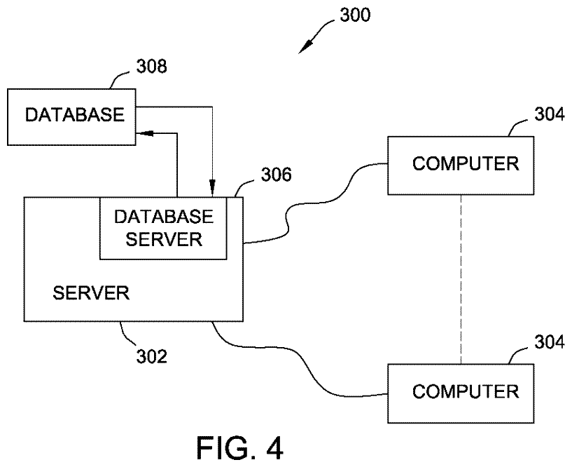

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale device. This may include bundling of approved transactions daily for standard retail purchases. When cardholder 22 cancels a transaction before it is captured, a “void” is generated. When cardholder 22 returns goods after the transaction have been captured, a “credit” is generated. Interchange network 28 and/or issuer 30 stores the payment card data, such as a type of merchant, amount of purchase, date of purchase, in a database 308 (shown in FIG. 4).

After a purchase has been made, a clearing process occurs to transfer additional transaction data related to the purchase among the parties to the transaction, such as merchant bank 26, interchange network 28, and issuer 30. More specifically, during and/or after the clearing process, additional data, such as a time of purchase, a merchant name, a type of merchant, purchase data, cardholder account data, a type of transaction, itinerary data, data regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, interchange network 28, and issuer 30. Settlement refers to the transfer of financial data or funds among merchant's 24 account, merchant bank 26, and issuer 30 related to the transaction. Usually, transactions are captured and accumulated into a “batch,” which is settled as a group. More specifically, a transaction is typically settled between issuer 30 and interchange network 28, and then between interchange network 28 and merchant bank 26, and then between merchant bank 26 and merchant 24.

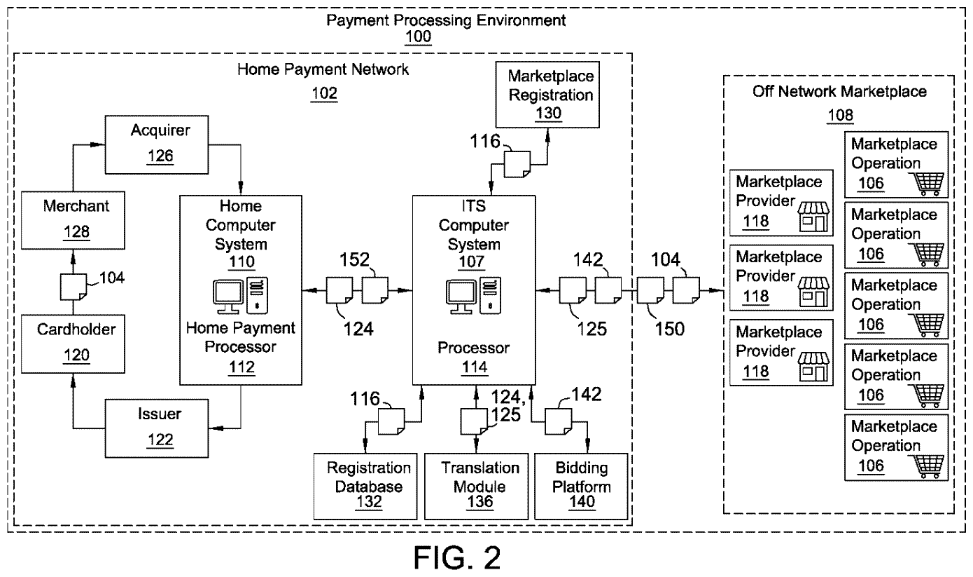

FIG. 2 is a block diagram showing a payment processing environment 100 in accordance with one embodiment of the present disclosure. Environment 100 includes a home payment network 102 and off-network marketplace 108 containing a plurality of marketplace providers 118 that are separate and distinct from entities contained within home payment network 102. Home payment network 102 may be similar to payment processing network system 20 shown in FIG. 1. As described above, entities contained in the home payment network 102 include the cardholder 120, the merchant 128, the issuer 122, and/or the acquirer 126 participating in the payment transaction 104. Marketplace providers 118 may be one or more entities that are not included in the home payment network 102 listed above.

In the example embodiment, a payment transaction 104 represented by data included within a payment transaction message originates on home payment network 102 and entities within home payment network 102 may request marketplace enrichment operations 106 to be applied to payment transaction 104 by one or more marketplace providers 118 in the off-network marketplace 108. The home payment network 102 includes a home computer system 110 and an associated home network processor 112 for generating an initiating service request 124 (formatted in accordance with in-network protocols and/or standards), requesting a marketplace operation 106. The home payment network 102 includes a translation module 136 configured to convert initiating service request 124 to an off-network service request 125 and to transmit off-network service request 125 to off-network marketplace 108 and/or directly to a marketplace provider 118. Home payment network 102 includes, or may be associated with, an instream transaction services (ITS) computer system 107 and associated instream processor 114 that may receive and/or process the off-network service request 125 and/or transmit the off-network service request 125 to one or more marketplace providers 118. In some embodiments, the translation module 136 is supported by the ITS computer system 107, and the ITS computer system 107 facilitates translation of service requests 124, 125.

Home payment network 102 includes entities such as cardholder 120, issuer 122, acquirer 126, merchant 128, and home computer system 110 associated with the home payment network 102. Cardholder 120, issuer 122, acquirer 126, merchant 128, and home network processor 112 may be similar to cardholder 22, issuer 30, merchant bank 26, merchant 24, and network processor 28 respectively, as shown in FIG. 1. Cardholder 120 is capable of initiating payment transaction 104 with merchant 128 by initiating payment transaction 104 with merchant 128. Payment transaction 104 may be represented by data included within a payment transaction message such as an authorization request message formatted using the ISO 8583 format or similar protocol. A requestor, requesting marketplace operations 106 to be applied to the payment transaction 104, may include any entity contained within the home payment network 102. Entities within the home payment network 102 may register for marketplace operations 106 using a marketplace registration platform 130 for generating a marketplace registration record 116, as described further herein. Marketplace registration platform 130 represents a web-based service allowing one or more parties within the home network 102 to register for marketplace operations 106 at a website hosted by either home computer system 110 and/or ITS computer system 107. In the example embodiment, entities may transmit registration information to instream processor 114, which converts registration information using translation module 136 to a format that may be received by ITS computer system 107.

In the example embodiment, marketplace registration record 116 may include a marketplace (MP) identifier associated with a marketplace operation 106 or a marketplace provider 118. The marketplace registration record 116 may be used, by the ITS computer system 107, during a look up procedure to determine a registered marketplace operation or marketplace provider. In some embodiments, the ITS computer system 107 may utilize data contained in the marketplace registration record 116 to build or generate the request messages 124, 125. In some embodiments, marketplace registration record 116 may include an account identifier associated with the payment card used to initiate the payment transaction 104, such as a primary account number (PAN), a real card number (RCN), or any other type of identifier that identifies or represents an account associated with payment transaction 104. In some embodiments, the marketplace identifier identifies a marketplace operation 106 or a marketplace provider 118 for which a requestor has registered a marketplace operation to be applied to a financial transaction. The marketplace identifier may be found using a lookup table or mapping techniques using the requestor identifier. In some embodiments, marketplace registration records 116 may include triggering conditions for triggering generating service request messages 124, 125, described herein.

Marketplace registration record 116 may be stored within a marketplace registration database 132 by the ITS computer system 107. Marketplace registration records 116 may be accessible by ITS computer system 107 for retrieval, in real-time (e.g., upon receiving of payment transaction 104 and during authorization processing of payment transaction 104).

The marketplace providers 118 contained in the off-network marketplace 108 may register, and/or are vetted in an approval process, by ITS computer system 107 and/or the home computer system 110 to participate in the off-network marketplace 108 and offer marketplace operations 106 to entities included in the home payment network 102. In some embodiments, one or more marketplace providers 118 may offer the same, or substantially similar, marketplace operations 106. Marketplace providers 118 may be registered as a type of provider associated with the marketplace operation 106 that is offered by the marketplace provider 118. For example, marketplace operations 106 may include, and without limitation, an insurance service, a tax compliance service, a data enrichment service, a transaction notification service, a digital receipt service, a loyalty service, a gamification service, a fraud evaluation service, a digital provisioning payment service, a virtual card mapping service. For example, an insurance marketplace provider may provide marketplace operations 106 including fraud chargeback liability insurance, a guaranteed settlement insurance, and/or a guaranteed delivery insurance on a forward sold good or service (e.g., flight tickets, concert tickets, and the like).

In some embodiments, marketplace providers 118 provide marketplace operations 106 in real-time, during or immediately after initiation of payment transaction 104 on home payment network 102 between cardholder 120 and a merchant 128. In other words, the marketplace operations 106 may be applied to the payment transaction message while the payment transaction message (authorization message) is in flight and being processed for payment such that the enrichment operation is applied to the transaction before the transaction is completed. In some embodiments, marketplace operations 106 are applied to payment transaction 104 during any suitable time between clearing and settlement processes occurring on home payment network 102 (e.g., between merchants 128 and acquirers 126).

In embodiments described herein, the ITS computer system 107 may include a bidding platform 140 for evaluating (e.g., comparing, accepting, declining, and/or submitting counteroffers) a plurality of bids 142 received from a plurality of marketplace providers 118. Each of the bids 142 may include a service fee associated with applying the marketplace operation 106, estimated time to perform the marketplace operation 106, a description of the marketplace operation 106 associated with the bid 142, and/or any other suitable information. In embodiments described herein, the bidding platform 140 may be supported by the ITS computer system 107, or, alternatively, the bidding platform 140 may be supported by a separate computer system in communication with the ITS computer system 107. The bidding platform 140 may select a “winning” marketplace provider 118 for a registered marketplace operation 106 requested by a requestor, as will be described in greater detail herein.

In the payment processing environment 100, an initiating service request 124 may be sent by home network processor 112 which may request the marketplace operation 106 on behalf of another entity who is the recipient of the marketplace operation 106. The recipient (e.g., the requestor) includes one or more entities of the home payment network 102. In some embodiments, the initiating service request 124 may be sent by issuer 122 and/or any other entity including, but not limited to, acquirer 126, merchant 128, or cardholder 120.

Translation module 136, executed by the ITS computer system 107, converts the initiating service request 124 to off-network service request 125 that may be processed by a computing device associated with the marketplace provider 118. In the example embodiment, the translation module 136 is associated with a data layout protocol indicating a method of converting a first data file format associated with home payment network 102 (e.g., initiating service request 124) to a second data file format associated with off-network marketplace 108 (e.g., off-network service request 125). In alternative embodiments, the translation module 136 may include, without limitation, an algorithm for mapping service requests from the first data file format to the second data file format, or an automated program that converts initiating service request 124 to off-network service request 125. Translation module 136 is also configured to send off-network service request 125 to off-network marketplace 108. Translation module 136 also converts the off-network services responses 150 to the in-network services responses 152. The translation module 136 is accordingly also configured to convert a second data file format associated with off-network marketplace 108 to a first data file format associated with home payment network 102. In particular, the translation module 136 ensures that off-network service requests 125 conform to identical file naming conventions, file header conventions, file structure and layout conventions, file type conventions, and file size conventions. In an alternative embodiment, initiating service requests 124 are converted using XML-based transformational methods. In other embodiments, initiating service requests 124 may be converted using translation module 136 implementing any transformational method or language including, without limitation, Perl, AWK, TXL, or any other method capable of converting initiating service request 124 to apply names, headers, layouts, structures, file types, and file sizes required for off-network service request 125, and vis versa.

In some alternative embodiments, ITS computer system 107 may be triggered to generate service requests 124, 125, automatically, on behalf of a requestor, based on a received payment transaction 104 and a retrieved registration record 116. In some embodiments, ITS computer system 107 may automatically generate/convert/transmit service requests 124, 125, when the one or more triggering conditions are satisfied. For example, ITS computer system 107 may compare triggering conditions, contained within the registration record 116, with data contained within the payment transaction 104, to determine whether the trigger condition is satisfied. The ITS computer system 107, after being triggered to generate service requests 124, 125, may transmit the service requests 124, 125 to a suitable marketplace provider 118.

Instream processor 114 is representative of a computer system capable of communicating with home computer system 110 and receiving off-network service request 125 from translation module 136. Instream processor 114 is also capable of determining whether off-network service request 125 contains identifiers associated with marketplace operations 106 and/or marketplace providers 118. The ITS computer system 107 is configured to identify marketplace providers 118 and transmit the off-network service requests 125 to a computing device associated with the identified marketplace provider 118. In some embodiments, the instream processor 114 is capable of applying marketplace operations 106 to payment transaction 104. Transmitting requests 125 to the appropriate provider 118 means determining a computer address for sending the request to and creating an appropriate message header for the request so that the request is directed and received at the correct provider 118.

In some embodiments, the translation module 136, executed by the ITS computer system 107 or home computer system 110, translates registration records 116 to a format that can be used with ITS computer system 107 and/or computer systems associated with marketplace providers 118. For example, the translation module 136 converts registration data into a registration record 116 and transmits the registration record 116 to ITS computer system 107. In embodiments described herein, the translation module 136 may be used to convert a first data file format associated with home payment network 102 (e.g., registration data, payment request, and/or initiating service request 124) to a second data file format associated with off-network marketplace 108.

The initiating and/or off-network service requests 124, 125 may be associated with an authorization process, authorizing the application of one or more marketplace operations 106 to payment transaction 104. The service requests 124, 125 may include an identifier identifying a marketplace operation 106, a type of marketplace operation 106, and/or one or more marketplace providers 118. In some embodiments, the identifier is not associated with a specific marketplace provider 118, rather, the identifier identifies a registered marketplace operation 106 that may be provided by more than one marketplace providers 118 or by one of many providers 118. In some embodiments, the identifier is associated with a type of marketplace provider enabled to provide similar or related marketplace operations 106 for which the requestor is registered to receive.

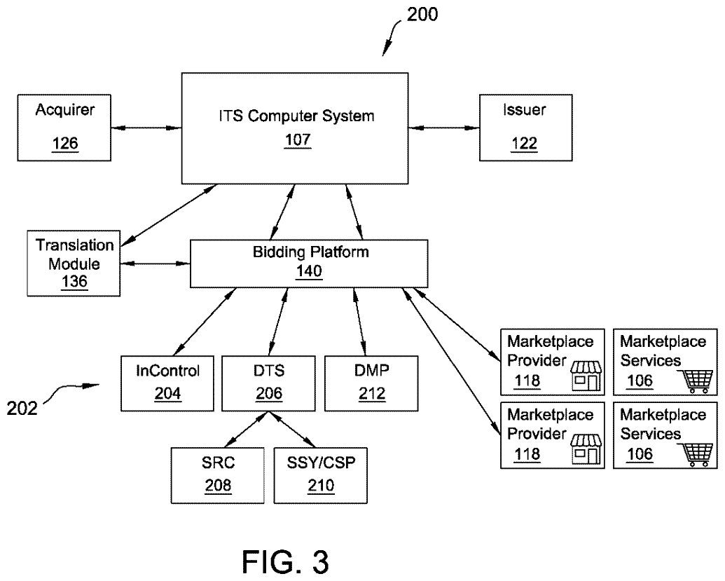

FIG. 3 is a data flow diagram illustrating additional details of a payment processing environment 200 that is similar to payment processing environment 100 shown in FIG. 2. In the example embodiment, off-network marketplace providers 118 utilize computer devices associated therewith to apply or execute marketplace enrichment operations 106 to payment transaction 104 including data from the payment transaction message. In addition, home network 102, which includes ITS computer system 107, also includes certain enrichment operations that may be provided within home network 102 to payment transaction 104. In other words, in the example embodiment, certain enrichment operations may be provided or executed on payment transaction 104 by either home network 102 or by off-network providers 118 or both.

The home network 102 may offer home network enrichment operations 202 offered by in-network parties, for example, InControl platform 204 (e.g., virtual card numbers or tokens for regulating or controlling spending such that spend amount limits may be applied or limits on types of merchants where purchases may or may not be performed), DTS 206 platform (e.g., for performing Digital Transaction Services such as Token Mapping or linking tokens to actual card numbers), SRC platform 208 (e.g., for performing secure remote commerce), and SSY/CSP platform 210 (e.g., for preforming Crypto Services), and/or DMP platform 212 (e.g., for performing decision management which may including Issuer Fraud Scoring systems) and/or Cyber and Intelligence platform (e.g., for performing fraud scoring and related tasks). These enrichment operations 202, performed by the in-network platforms, may be executed on a payment transaction 104 that is initiated over home network 102, and an output message indicating the application of an operation, may be provided back to ITS computer system 107 which then may transmit the message to other parties within home network 102. In some cases, that same message may also be provided to off-network marketplace providers 118 to perform their services 106 to payment transaction message 104. In other words, in some embodiments, both off-network operations 106 and in-network operations 202 may be applied to the same payment transaction message 104.

For example, instream services may be performed by the ITS computer system 107 on-behalf of the issuer 122 and decline a payment transaction 104 (e.g., when a fraud probability score is too high). In another example, CSP 210 may determine if a cryptogram has been applied to a pay transaction 104, e.g., on behalf of the home payment network 102. In some embodiments, the bidding platform 140 may receive, compare, and select bids 142 from the off-network marketplace 108 and/or bids 142 for home network enrichment operations 202 offered by in-network parties. In some embodiments, one or more in-network platforms, e.g., InControl platform 204, DTS 206 platform, SRC platform 208, SSY/CSP platform 210, DMP platform 212, and/or the Cyber and Intelligence platform may exchange data or information with the ITS computer system 107. ITS computer system 107 may utilize the translation module 136 to translate the data or information to be received in a suitable format, e.g., readable, by off-network marketplace 108, when the ITS computer system 107 transmits, e.g., forwards, the data or information to off-network marketplace 108. For example, ITS computer system 107 may transmit a fraud score, determined by an in-network platform, to off-network marketplace 108.

In some embodiments, the bids 142 may be received prior to payment transaction 104 being initiated. For example, conditional bids 142 may be previously submitted, e.g., by marketplace providers 118 and/or in-network platforms, having conditional criteria. Home computer system 110 and/or the ITS computer system may store bids 142, e.g., in marketplace registration record 116 and/or marketplace registration database 132, for retrieval during a payment transaction 104, such that the bidding process may be performed in real-time, e.g., while the transaction 104 is being initiated by a cardholder 120. Bidding platform 140 may compare received bids 142, e.g., received after initiation of payment transaction message 104 and/or bids 142 retrieved from database 132, if payment transaction message 104 meets the criteria for the conditional bid 142.

Within processing environment 100 and 200, cardholder 120 initiates payment transaction 104 over home payment network 102 with merchant 128 using a payment card. The computer message of payment transaction 104 includes an account identifier (e.g., a PAN) and transaction details. Payment transaction 104 also includes payment transaction data. The payment transaction data may include, without limitation, the time of payment transaction 104, the date of payment transaction 104, the amount of payment transaction 104, merchant 128 associated with payment transaction 104, the category associated with merchant 128 associated with payment transaction 104, the geographic location of payment transaction 104, and the purchase category (e.g., food, clothing, or computers) of payment transaction 104 along with other transaction data. In some embodiments, the transaction data contained in the payment transaction 104 is included in the service request 124, 125.

Merchant 128, through acquirer 126, sends payment transaction 104 data as an authorization request message over home payment network 102 for processing payment transaction 104. Acquirer 126 sends the authorization request along to issuer 122. In one embodiment, acquirer 126 transmits the authorization request message to ITS computer system 107 which determines whether the account associated with payment transaction 104 is eligible for marketplace operations 106 by retrieving a marketplace registration record 116 from marketplace registration database 132. In alternative embodiments, ITS computer system 107 sends the authorization request message to issuer 122, and issuer 122 determines whether any in-network party associated with payment transaction 104 is eligible for marketplace operations 106. In some cases, it may also be determined whether payment transaction 104 is eligible for home network enrichment operations 202. In the example embodiment, ITS computer system 107 will search a memory device, such as marketplace registration database 132, to determine whether the identifier is registered for marketplace enrichment operations 106. In other embodiments, issuer 122 will search a memory device, such as marketplace registration database 132, to determine whether the identifier is registered for marketplace operations 106. When the payment transaction 104 is eligible, the ITS computer system 107 may generate initiating service request 124 and/or convert initiating service request 124 to off-network service request 125.

The ITS computer system 107 processes the off-network service request 125 by applying registered marketplace operations 106 to the payment transaction 104 or a process associated with the payment transaction 104 (e.g., insurance coverage for the full or partial transaction amount). In some embodiments, computing devices associated with marketplace providers 118 applies the marketplace operations 106. The term applying, as it relates to the marketplace operation 106, is a generic term describing execution of the marketplace operation 106, when off-network service request 125 requires such application. If marketplace operation 106 should be applied, the ITS computer system 107 or computer system associated with the marketplace provider 118 generates off-network service response 150 based, at least in part, on applied marketplace operations 106, payment transaction 104 associated with off-network service request 125 and/or a confirmation that the marketplace operation 106 has been applied to the payment transaction 104. ITS computer system 107, using translation module 136, converts the off-network service response 150 to the in-network service response 152, and then ITS computer system 107 transmits the in-network services response 152 to home computer system 110. In some embodiments, off-network services response 150 are routed directly to translation module 136.

Here, translation module 136 facilitates converting the off-network services responses 150 into the in-network services responses 152. The translation module 136 is now used to reverse the process described when initiating service request 124 was converted to off-network service request 125. The translation module 136 allows a reversed conversion of off-network services responses 150 into the in-network services responses 152 conforming to identical file naming conventions, file header conventions, file structure and layout conventions, file type conventions, and file size conventions associated with home payment network 102. In the example embodiment, off-network services responses 150 are converted using the translation module 136 implementing XML-based transformational methods. In alternative embodiments, off-network service responses 150 may be converted using the translation module 136 implementing any transformational method or language including, without limitation, Perl, AWK, TXL, or any other method capable of converting the off-network services responses 150 to apply names, headers, layouts, structures, file types, and file sizes required for the in-network services responses 152.

The in-network services response 152 is then transmitted back to the requestor (e.g., home network processor 112, issuer 122, or any other suitable in-network party) registered for the marketplace operation 106. In the example embodiment, when the requestor is home network processor 112, the requestor will communicate with acquirer 126 (e.g., return an authorization response denying or approving a payment transaction 104 to merchant 128 based upon the application of transaction rules and limits service) and/or cardholder 120 (e.g., to alert cardholder based upon the application of marketplace operations 106) depending on the contents of the in-network services response 152. In alternative embodiments, when the requestor is issuer 122, the requestor will either act on the contents of the in-network services response 152 (e.g., instruct acquirer 126 to deny or approve a payment transaction 104 based upon the application of transaction rules and limits service) or communicate with cardholder 120 (e.g., to alert cardholder based upon the application of marketplace operations 106).

In a first example, a requestor including an issuer 122 may register, using a marketplace registration record 116, for a marketplace operation 106 including insuring payment transaction 104. In particular, in this first example, the registration record 116 is registered for marketplace operation 106 including an insurance service for payment transactions 104 that have been flagged as at a high risk of being fraudulent. Initiating of payment transaction 104 (e.g., receiving a payment transaction at the home computer system 110) may cause the ITS computer system 107 and/or the home payment computer system 100 to generate service request 124. Alternatively, the service request 124 may be generated by the requestor or by another in-network entity, on behalf of the requestor. In some embodiments, the initiating service request 124 is triggered to be generated and transmitted when the one or more triggering conditions are satisfied. In the first example, the triggering condition may include flagging, by the issuer 122 or the acquire 126 or an alternative financial institution, the payment transaction 104 as being at a high risk of being fraudulent, or potentially fraudulent (or high risk for another reason such as at risk for whether the purchased goods or services will be provided). The ITS computer system 107 may determine that the off-network service request 125 is associated with an account identifier which is registered for marketplace operations 106.

ITS computer system 107 processes both in-network service request 124 and payment transaction 104 and determines that in-network service request 124 is associated with payment transaction 104 which has been flagged as at risk for fraud. In some embodiments, ITS computer system 107 may also determine marketplace operations 106 requires that the requestor must alert cardholder 120, issuer 122, and/or acquirer 126 of the fraudulent flag. Initiating service request 124 is converted using translation module 136 to off-network service request 125, which is then transmitted to computing devices associated with marketplace providers 118. Subsequently, off-network services response 150 is converted to the in-network services response 152 using translation module 136. The in-network services response 152 is sent to the requestor, e.g., the issuer. The ITS computer system 107 sends an electronic alert to a computer system associated with issuer 122 and/or merchant 128 indicating that the insurance marketplace provider has insured the payment transaction 104.

In some embodiments, the home payment network 112 transmits supplemental data to the off-network marketplace 108 and/or to one or more marketplace providers 118. Supplemental data may include data separate and distinct from the data contained within the transaction message (authorization message) of payment transaction 104. Supplemental data may include transaction velocity and/or data associated with the in-network entities, e.g., merchant and/or the cardholder involved in the payment transaction 104. The marketplace provider 118 may utilize the supplemental data, in addition to the data contained within the payment transaction 104, to determine whether the marketplace provider 118 will provide the marketplace operation 106. The marketplace provider 118 may utilize the supplemental data and/or the payment transaction 104 to determine, and/or propose to the requestor, a type of marketplace operation 106 (e.g., a type of insurance and an associated fee). In some embodiments, the marketplace provider 118 may receive data associated with a flagged fraudulent payment transaction 104 (e.g., type of fraud, etc.) and the marketplace provider 118 may use this provided information to determine an insurance bid 142. Additionally, and/or alternatively, marketplace provider 118 may utilize the supplemental data to determine and/or assess the risk associated with payment transaction 104 (e.g., such as determining a fraud type or a likelihood of fraud, etc.) enabling the marketplace provider 118 to determine an insurance bid 142. A marketplace provider 118 of a given service type adheres to the expected payload enrichments. A service type, e.g., Txn Guarantee, has associated payload enrichments and therefore is deliverable by multiple service providers.

In the exemplary embodiment, the bidding platform 140 may receive a plurality of insurance bids 142 including an associated fee. The bidding platform 140 may compare the bids 142 and select a bid 142 and an associated marketplace provider 118 based on the lowest fee. Bidding platform 140 may select a bid 142 based on alternative and/or additional criteria, such as a preference, e.g., a preferred marketplace provider 118 identified by the requestor. The preferred marketplace provider 118 may be identified in the marketplace registration record 116. In some embodiments, marketplace providers 118 may include an associated rank or score, e.g., based on customer satisfaction or any other suitable criteria, and the bidding platform 140 may utilize the score to select a winning bid 142. Accordingly, the bidding platform 140 may be a static process wherein the marketplace provider 118 is selected based on one or more rules or, alternatively, the bidding platform 140 may be a dynamic process wherein the marketplace provider 118 is selected based on transaction conditions, e.g., supplemental data and/or data contained within the payment transaction 104. This dynamic process, e.g., selecting suitable marketplace providers 118 and/or suitable marketplace operations 106, may be managed by a dynamic marketplace provider selection platform.

In a second example, a requestor (e.g., cardholder or acquirer) may register using marketplace registration record 116 for a marketplace operation 106 including guaranteeing payment transaction 104 associated with a forward-sold good and/or service. Accordingly, in the second example, the registration record 116 is registered for marketplace operations 106 including guaranteed delivery for transactions having a condition of payment transaction 104 initiated for forward-sold goods and services. Again, payment transaction 104 results in initiating service request 124 being generated by the requestor, or another entity on behalf of the requestor. Initiating service request 124 is again converted using translation module 136 to off-network service request 125 and an off-network service response 150 is received, similar to the first example. In some embodiments, in addition to generating an in-network services response 152 (informing the requestor that the marketplace operation 106 has been applied to the financial transaction), ITS computer system 107 may send an SMS text message directly to a computer system associated with requestor.

In a third example, a requestor, including any and/or all of the in-network parties, may register using marketplace registration record 116 for a marketplace operation 106 including covering party exposure for payment transactions 104. Party exposure may generally refer to risk associated with a payment transaction 104 for any and/or all in-network parties. Accordingly, in the third example, the registration record 116 is registered for marketplace operations 106 including guaranteed party exposure, regardless of the requestor.

In some embodiments, when the payment transaction 104 is not eligible, normal authorization processing is performed by issuer 122 and issuer 122 returns a normal authorization response to acquirer 126 and acquirer 126 returns the authorization response to merchant 128 and cardholder 120.

FIG. 4 is a simplified block diagram of an example computer system 300 representative of ITS computer system 107 or the home computer system 110 in payment processing environment 100 or 200 (both shown in FIGS. 2 and 3). In the example embodiment, system 300 includes a server system 302 and a plurality of client subsystems, also referred to as client systems 304, connected to server system 302. In one embodiment, client systems 304 are computers including a web browser, such that server system 302 is accessible to client systems 304 using the Internet. Client systems 304 are interconnected to the Internet through many interfaces including a network, such as a local area network (LAN) and/or a wide area network (WAN), dial-in connections, cable modems, wireless-connections, and special high-speed ISDN lines. Client systems 304 may be any device capable of interconnecting to the Internet including a web-based phone, personal digital assistant (PDA), or other web-connectable equipment. A database server 306 is connected to a database 308 containing information on a variety of matters, as described below in greater detail. In one embodiment, database 308 is stored on server system 302 and may be accessed by potential users at one of client systems 304 by logging onto server system 302 through one of client systems 304. In any alternative embodiment, database 308 is stored remotely from server system 302 and may be non-centralized.

As discussed below, payment card information including account numbers, payment card numbers, expiration dates, and account statuses, such as whether the account is open or closed, is stored within database 308. Further, data relating to the cardholder of a payment card may also be stored within database 308. Such cardholder data may include, for example, cardholder name and cardholder billing address.

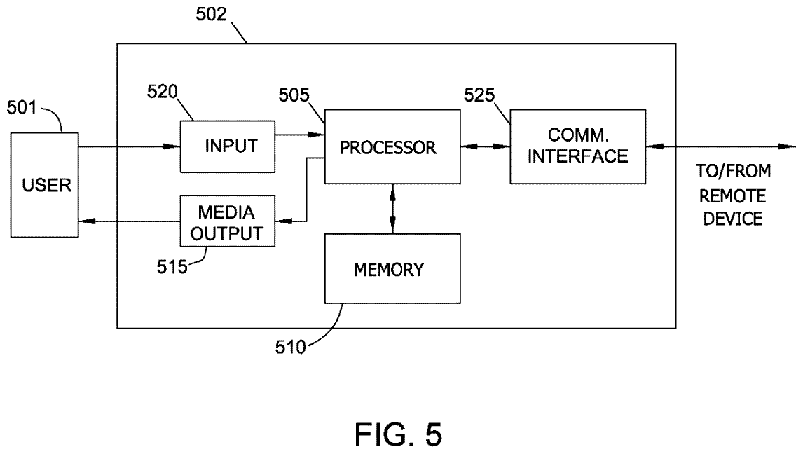

FIG. 5 illustrates an example configuration of a cardholder computer system 502 operated by a cardholder 501 or some other user device. Cardholder computer system 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer readable media.

Cardholder computer system 502 also includes at least one media output component 515 for presenting information to cardholder 501. Media output component 515 is any component capable of conveying information to cardholder 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computer system 502 includes an input device 520 for receiving input from cardholder 501. Input device 520 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 515 and input device 520.

Cardholder computer system 502 may also include a communication interface 525, which is communicatively couplable to a remote device such as server system 302 or a web server operated by a merchant. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer readable instructions for providing a user interface to cardholder 501 via media output component 515 and, optionally, receiving and processing input from input device 520. A user interface may include, among other possibilities, a web browser and client application. Web browsers enable cardholders, such as cardholder 501, to display and interact with media and other information typically embedded on a web page or a website from server system 302 or a web server associated with a merchant. A client application allows cardholder 501 to interact with a server application from server system 302 or a web server associated with a merchant.

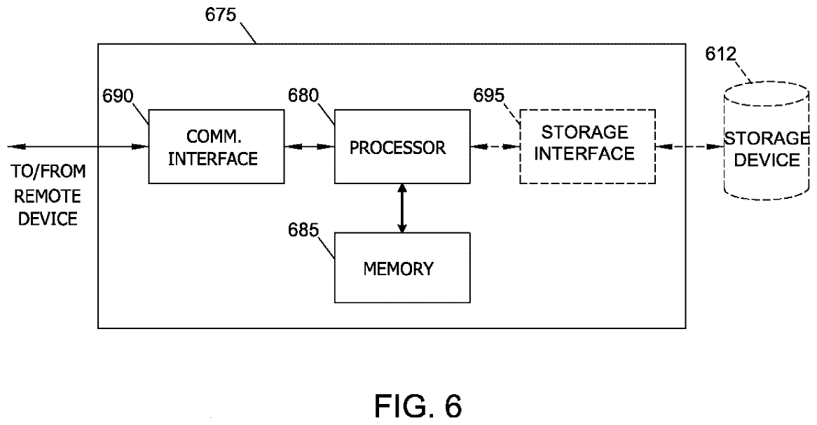

FIG. 6 illustrates an example configuration of a server computer system 675 such as server system 302 (shown in FIG. 4) or home computer system 110 and ITS computer system 107 (shown in FIG. 2). Server computer system 675 may include, but is not limited to, database server 306

Server computer system 675 includes a processor 680 for executing instructions. Instructions may be stored in a memory area 685, for example. Processor 680 may include one or more processing units (e.g., in a multi-core configuration).

Processor 680 is operatively coupled to a communication interface 690 such that server computer system 675 is capable of communicating with a remote device such as cardholder computer system 502 (shown in FIG. 6) or another server computer system 675. For example, communication interface 690 may receive requests from client systems 304 via the Internet, as illustrated in FIGS. 4 and 5.

Processor 680 may also be operatively coupled to a storage device 612 similar to storage device 412 (shown in FIG. 5). Storage device 612 is any computer-operated hardware suitable for storing and/or retrieving data. In some embodiments, storage device 612 is integrated in server computer system 675. For example, server computer system 675 may include one or more hard disk drives as storage device 612. In other embodiments, storage device 612 is external to server computer system 675 and may be accessed by a plurality of server computer systems 675. For example, storage device 612 may include multiple storage units such as hard disks or solid-state disks in a redundant array of inexpensive disks (RAID) configuration. Storage device 612 may include a storage area network (SAN) and/or a network attached storage (NAS) system.

In some embodiments, processor 680 is operatively coupled to storage device 612 via a storage interface 695. Storage interface 695 is any component capable of providing processor 680 with access to storage device 612. Storage interface 695 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 680 with access to storage device 612.

Memory area 685 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only and are thus not limiting as to the types of memory usable for storage of a computer program.

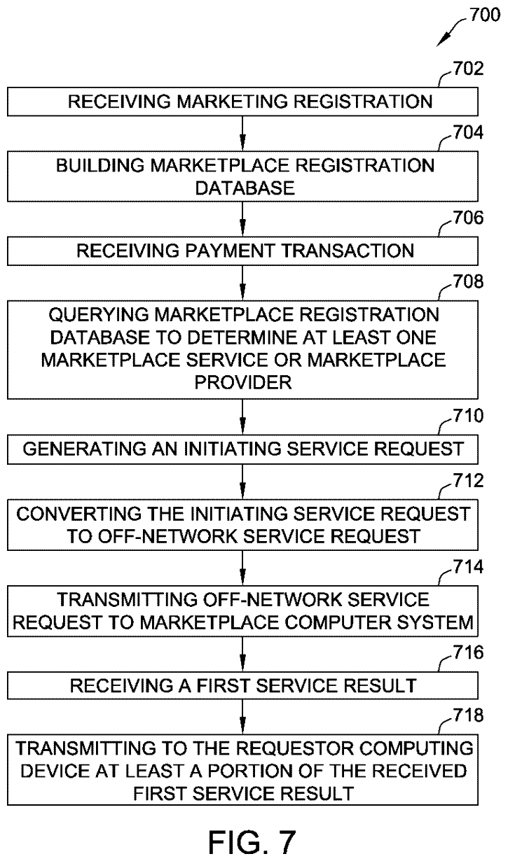

FIG. 7 is a flow diagram of an example method 700 of implementing off-network marketplace 108 offering marketplace operations 106 provided by one or more marketplace providers 118 to payment transaction 104 initiated by the cardholder 120 at the merchant 128 in the home payment network 102. Method 700 may be implemented using a computer system such as home computer system 110, computer systems associated with in-network parties, and/or ITS computer system 107, shown in FIG. 2.

Method 700 includes receiving 702, by the ITS computer system 107, a marketplace registration record 116 registering an entity within the home network for a marketplace operation 106 and/or a marketplace provider 118 within the off-network marketplace 108. The marketplace registration record 116 may be generated by one or more requestor computer systems associated with one or more in-network parties within the home payment network 102 requesting a marketplace operation 106. In some embodiments, the ITS computer system 107 may generate the marketplace registration record 116, on behalf of an entity in the home payment network 102. The marketplace registration record 116 may include one or more identifiers. The one or more identifiers may include an account identifier, a requestor identifier, and/or a marketplace identifier, for example. The marketplace identifier may uniquely identify a marketplace operation and/or a marketplace provider. In some embodiments, method 700 may include the computer system building 704 the marketplace registration database 132 using a plurality of received and/or generated marketplace registration records 116.

Method 700 includes receiving 706, at the ITS computer system 107, payment transaction 104 including a plurality of elements. In some embodiments, payment transaction 104 is formatted according to a communications standard for exchange of financial transaction data between financial institutions, the communications standard defining a plurality of data fields to be included within data signals compliant with the communications standard. The payment transaction 104 may be also formatted according to a hypertext transfer protocol (HTTP).

Method 700 also includes the computer system querying 708 marketplace registration database 132 using data contained within the received payment transaction 104, where the query returns a marketplace registration record 116 containing an identification of a marketplace operation 106 and/or marketplace provider 118 for which the one or more identifiers is registered. Data contained within the received payment transaction 104, utilized to query the marketplace registration database 132, may include entities participating in the transaction, e.g., merchant, issuer, and/or acquirer and/or the identifier associated with these entities. Querying may include using any other suitable data contained within the transaction request to retrieve a marketplace registration record 116. In some embodiments, method 700 includes receiving, at the computer system, a marketplace request message that is separate from the payment transaction 104, including one or more identifiers for querying the marketplace registration database 132 and/or requesting a marketplace operation 106 to be applied to the payment transaction 104.

Method 700 includes the computer system device generating 710 an initiating service request 124 using data contained within the marketplace registration record 116 and/or payment transaction 104.

Method 700 includes the computer system utilizing the translation module 136 for converting initiating service request 124 to off-network service request 125 which is formatted to be processed by either the ITS computer system 107 and/or a computer system associated with marketplace provider 118, at off-network marketplace 108.

Method 700 further includes the ITS computer system 107 transmitting 714 at least a portion of off-network service request 125 to ITS computer system 107 and receiving 716, e.g., from the ITS computer system 107, a first services result signal indicating a result of the application of the off-network service request 125 to the payment transaction 104. In some embodiments, method 700 includes the computer system transmitting the off-network service request 125, e.g., directly, to marketplace provider 118 and receive from marketplace provider 118, the first services result signal indicating a result of an application of off-network service request 125 to the payment transaction 104.

Method 700 also includes transmitting 718, from the ITS computer system 107 to the requestor computer system, the in-network service response message 152 that includes a consolidated response code, the consolidated response code indicating the application of a marketplace operation 106 to payment transaction 104. In some embodiments, the in-network service response message 152 identifies a marketplace operation 106 that was applied to the payment transaction 104. In other embodiments, the in-network service response message 152 further includes a plurality of service-result codes, each of the plurality of service-result codes indicating a separate result of the application of a corresponding service of a plurality of marketplace operations 106.

In some embodiments, method 700 may include repeating, or duplicating, one or more steps described above, enabling multiple marketplace operations 106 to be applied to a single transaction request. The method steps may be performed or applied to a payment transaction 104 in tandem and/or simultaneously, such that a plurality of marketplace operations 106 are applied to an incoming payment transaction 104 in-real time, e.g., during a period of time between when a customer initiated the payment transaction 104, and a subsequent time when the payment transaction 104 is approved by the issuer, e.g., within 1-2 minutes or less than a minute.

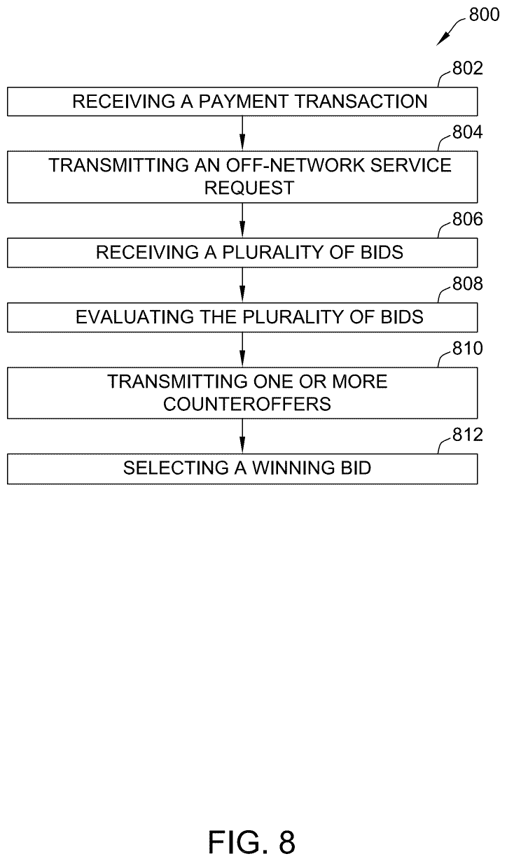

FIG. 8 is a flow diagram of an example method 800 for evaluating bids 142 (e.g., accepting, declining, or submitting counteroffers) for a marketplace operation 106 offered by more than one marketplace provider 118 in the off-network marketplace 108. One or more steps of method 800 may be implemented by one or more computer systems, e.g., home payment computer system, a computer associated with one or more in-network parties, and/or the ITS computer system 107, shown in FIG. 2.

Method 800 includes receiving 802, at the ITS computer system 107, a payment transaction 104 initiated by the cardholder 120 at the merchant 128. Method 800 also includes receiving, retrieving, and/or generating a marketplace registration record 116, on behalf of one or more in-network parties contained within the home payment network 102, as described above with respect to method 700. Method 800 may include generating, using the ITS computer system 107, and/or a computer system of an in-network party, an initiating service request 124, based on, for example, the marketplace registration record 116 and/or the payment transaction 104. In some embodiments, method 800 may include receiving, at the ITS computer system 107 from a requestor computer system, the initiating service request 124 associated with the payment transaction 104. The initiating service request 124 may include an indication that the requestor is registered, e.g., in the marketplace registration database 132, to receive a marketplace operation 106 from a marketplace provider 118 selected from a plurality of marketplace providers 118, based on a bidding process. In some embodiments, the bidding platform 140 may transmit/receive one or more messages with in-network parties, e.g., the requestor, to evaluate bids 142, accept bids 142, and/or generate counteroffers. Accordingly, method 800 includes one or more steps, performed by the bidding platform 140, enabling in-network parties to select bids 142, select marketplace providers 118, select marketplace operations 106, etc., and the like.

Method 800 includes the ITS computer system 107 converting the initiating service request 124 to the off-network service request 125 using the translation module 136. Upon translation to the off-network services request, method 800 includes transmitting 804, by the ITS computer system 107, the off-network service request 125 to the ITS computer system 107, which will direct the off-network service request 125 to one or more suitable marketplace providers 118. Method 800 may also include transmitting, using the ITS computer system 107, the payment transaction 104 associated with the off-network service request 125 to the ITS computer system. In some embodiments, method 800 includes the ITS computer system 107 compiling the off-network service request 125 and the payment transaction 104 into a single message that is transmitted to the ITS computer system and/or computer systems associated with marketplace providers 118. In some embodiments, the ITS computer system 107 may transmit the off-network service request 125 and/or the payment transaction 104 directly, without being routed through the ITS computer system 107, to one or more appropriate marketplace providers 118.

Method 800 may include one or more steps to select a single marketplace provider 118 from a plurality of available marketplace providers 118, for applying the registered marketplace operation 106 to the payment transaction 104. Method 800 includes receiving 806, at the ITS computer system 107 and/or the bidding platform 140, a plurality of bids 142 from the ITS computer system and/or computer systems associated with marketplace providers 118.

Method 800 includes the marketplace bidding platform 140 evaluating 808 bids 142. For example, the bids 142 may each include a service fee associated with applying the marketplace operation 106, and the marketplace bidding platform 140 may evaluate 808 the bids 142 by comparing the fee. In some embodiments, evaluating 808 the plurality of bids 142 may include scoring or ranking marketplace providers 118 who submitted bids 142. In some embodiments, evaluating 808 the plurality of bids 142 may include identifying a requestors preference. For example, in some embodiments, marketplace bidding platform 140 may evaluate a service provider, associated with a bid 142, based on criteria selected by requestor and/or criteria contained within marketplace registration record 116.

In some embodiments, method 800 includes generating and transmitting 810 one or more counteroffer messages to the ITS computer system 107 and/or the computer systems associated with one or more marketplace providers 118. The bidding platform 140 may generate counteroffers based on requestor criteria, contained in the registration record 116. For example, bidding platform 140 may generate and transmit a counteroffer based on requestor criteria including a max allowable fee, for example.

Method 800 includes selecting 812 a winning bid 142, and an associated marketplace provider 118, for providing the marketplace operation 106 to the payment transaction 104 based on the evaluation. The marketplace bidding platform 140 may select a marketplace provider 118 based on the evaluation, e.g., a comparison of bid fee, requestor preference, estimated time to perform the marketplace operation 106, etc. The marketplace bidding platform 140 may select a marketplace provider 118 based on one or more additional and/or alternative criteria.

In some embodiments, method 800 may include the bidding platform 140 declining one or more bids 142. Declining one or more bids 142 may include the bidding platform 140 transmitting one or more decline messages to the ITS computer system 107 and/or to one or more computers associated with the marketplace providers 118.

After the marketplace bidding platform 140 selects the winning bid 142 and the associated marketplace provider 118, method 800 includes the ITS computer system transmitting an approval message including an acceptance of a bid 142, an identified marketplace provider 118 associated with the accepted bid 142, and/or an approval to apply the marketplace operation 106 to the payment transaction 104. Method 800 includes computer system transmitting a decline message to one or more marketplace providers 118 declining a bid 142 offered by marketplace providers 118.

In some embodiments, method 800 includes receiving, from the ITS computer system, a first services result signal indicating a result of an application of the marketplace operation 106 provided by the selected marketplace bidding platform, to the payment transaction 104.

In some embodiments, method 800 further includes transmitting, to the requestor computer system, in-network service response message 152 identifying the selected marketplace provider 118 and/or the associated accepted bid 142, and the application of the service request to the payment transaction 104.

In one aspect of the present disclosure, a system and process for allowing approved third-parties (“transaction insurers”) the ability to assume the following in real time on a transaction: (i) fraud chargeback liability (thus obviating the need for an acquirer or issuer to do so); (ii) guaranteed settlement (often this is provided by another entity in a domestic card scheme (e.g., a central bank), however the bank may not have an up to date exposure position on the parties to the transactions; and (iii) guaranteed delivery insurance on a forward-sold good or service (flights, concerts etc.).

The systems and processes described herein is a novel network environment configured to “farm out” a transaction to multiple service providers (e.g., other regulated entities) who may wish to provide a service on the transaction “in-flight.”

In the example embodiment, a payment card scheme involves relationships between registered banks (both issuer and acquirers) and furthermore relationships between merchants and their acquirers. These are necessary to facilitate movement of payment transactions on the payment network and also to allow clearing and settlement to occur between the relevant parties. A given registered bank undergoes due diligence to gain access to the network. Similarly, a merchant undergoes due diligence to gain access via its acquirer to the network. The merchant, acquirer, issuer, cardholder and indeed the home processing network can be considered parties to the transaction.

In the example of the in-flight insurance enrichment service, insurance providers are usually regulated entities within a given jurisdiction. Each must be registered in advance as an insurance provider on one or more of the types of transaction guarantee. Insurance providers may have their own relationship/knowledge of the parties to the transaction. Each party to the transaction has his own identifier. In an ISO 8583 type message, these can be determined or derived as follows: DE 32 (Data Element for Acquirer Identifier); DE 42+DE32 (Merchant Identifier). Alternatively, DE43 etc. may be used. DE2 (Card Identifier—first N digits represents a BIN—effectively can derive a Card Issuer.) The insurance providers can thus use previous transaction velocity, current transaction specifics and possibly knowledge of parties to the transaction to propose one of the insurance types along with their proposed fee. The bidding platform evaluates the bids and based on best value or other criteria (e.g., issuer or acquirer or merchant has a preferred provider per Txn type) can if appropriate inject the insurance identifier into the transaction message. Thus, the logic in the bidding platform could be either static (up front rules for customer or network) or dynamic (e.g., based on transaction conditions).

By way of example, an issuer is made aware that another entity is proposing an enrichment operation (e.g., fraud chargeback liability). The issuer can choose—by way of data element enrichment (0110 Response)—whether the issuer wishes to accept that rather than decline. Thus, reducing certain decline scenarios. A merchant similarly in situations where the merchant may be at risk can choose to accept and proceed with third-party liability or reverse the transaction.

By way of another example, the payment network may not have an up-to-date picture of the party exposure. However, an insurance provider has proposed a settlement guarantee for a small fee. This is accepted and the transaction is allowed to proceed rather than turned around by the network.

By way of another example, a cardholder or an acquirer is not sure about buying (or guaranteeing) a credit card purchase of a flight with a certain (higher risk) airline. However, an insurance company takes the delivery liability etc.

By way of another example, instream transaction services interface (TSI) enriches a transaction with multiple providers for a given service, and the issuer is able to select which service enrichment it accepts (via s Data Element enrichment in the Response message). The systems and methods described herein benefit all parties to the transaction as it facilitates insurance companies providing guarantees versus using default card scheme rules.

This written description uses examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An instream transaction services computer system comprising a memory and at least one processor in communication with the memory, the memory storing instructions executable to cause the at least one processor to:
receive a payment transaction message including one or more identifiers;
query a marketplace registration database using the one or more identifiers contained in the payment transaction message to retrieve a registration record, wherein the registration record includes an identification of at least one of a marketplace provider and an enrichment operation;
generate an operation request message based on the identified at least one marketplace provider and the enrichment operation;
transmit at least a portion of the operation request message to the identified marketplace provider;
in response to the transmission, receive an operation result message from the identified marketplace provider including an output result of the enrichment operation being applied to the payment transaction message; and
transmit, to a requestor computer system, a response message indicating the output result of the enrichment operation being applied to the payment transaction message.

2. The instream transaction services computer system according to claim 1, wherein the operation request message includes computer instructions executable to cause said at least one processor to:
transmit the operation request message via a gateway for an application programming interface (API), the API defining a plurality of parameters corresponding to a plurality of data fields of a communications standard for exchange of financial transaction data between financial institutions.

3. The instream transaction services computer system according to claim 1, wherein the requestor is an in-network party associated with a processing network where the payment transaction message was initiated, the in-network party including at least one of a cardholder who initiates the payment transaction, a merchant at which the payment transaction was initiated, an issuer associated with the cardholder, and an acquirer associated with the merchant.

4. The instream transaction services computer system according to claim 1, wherein marketplace providers do not include an issuer, a merchant, and an acquirer, and wherein the marketplace providers include computing devices hosted on a separate off-network system.

5. The instream transaction services computer system according to claim 1, wherein the operation request message includes instructions executable to cause said at least one processor to:
generate the operation request message based on the identified at least one marketplace provider and enrichment operation, wherein the operation request message is formatted according to a communications standard for exchange of financial transaction data between financial institutions, the communications standard defining a plurality of data fields to be included within messages compliant with the communications standard, and wherein the operation request message is configured to cause a computing device associated with the marketplace provider to execute the enrichment operation on the transaction data.

6. The instream transaction services computer system according to claim 1, wherein the processor is further configured to:
receive an initiating operation request message from the requestor; and
translate the initiating operation request message to generate the operation request message.

7. The instream transaction services computer system according to claim 1, wherein the processor is further configured to:
generate one or more marketplace registration records registering requestors for at least one of an enrichment operation and marketplace provider, wherein the marketplace registration record includes one or more identifiers including at least one of an account identifier, a requestor identifier, or a marketplace identifier; and
build a marketplace registration database by storing one or more generated marketplace registration records.

8. The instream transaction services computer system according to claim 1, wherein the enrichment operation comprises services from among an insurance service, a tax calculation service, a cross-border service, a data enrichment service, a transaction notification service, a digital receipts service, a loyalty service, a virtual card mapping service, a digital payment credential provisioning service, a fraud evaluation service, a virtual card mapping service, a digital payment credential provisioning service, and a fraud evaluation service.

9. A computer-implemented method using an instream transaction services computer system having a memory and at least one processor in communication with the memory and with a plurality of services platforms, the method comprising:
receiving a payment transaction message including one or more identifiers;
querying a registration database using the one or more identifiers contained in the payment transaction message to retrieve a registration record, wherein the registration record includes an identification of at least one of a marketplace provider and an enrichment operation;
generating an operation request message based on the identified at least one marketplace provider and enrichment operation;
transmitting at least a portion of the operation request message to the identified marketplace provider;
in response to the transmitting, receiving an operation result message from the identified marketplace provider including an output result of the enrichment operation being applied to the payment transaction message; and
transmitting, to a requestor computer system, a response message indicating the output result of the enrichment operation being applied to the payment transaction message.

10. The computer-implemented method according to claim 9, wherein the method further includes:
transmitting the operation request message via a gateway for an application programming interface (API), the API defining a plurality of parameters corresponding to a plurality of data fields of a communications standard for exchange of financial transaction data between financial institutions.

11. The computer-implemented method according to claim 9, wherein the requestor is an in-network party associated with a processing network where the payment transaction message was initiated, the in-network party including at least one of a cardholder who initiates the payment transaction, a merchant at which the payment transaction was initiated, an issuer associated with the cardholder, and an acquirer associated with the merchant.

12. The computer-implemented method according to claim 9, wherein marketplace providers do not include an issuer, a merchant, and an acquirer, and wherein the marketplace providers include computing devices hosted on a separate off-network system.

13. The computer-implemented method according to claim 9, wherein the method further includes:
generating the operation request message based on the identified at least one marketplace provider and enrichment operation, wherein the operation request message is formatted according to a communications standard for exchange of financial transaction data between financial institutions, the communications standard defining a plurality of data fields to be included within messages compliant with the communications standard, and wherein the operation request message is configured to cause a computing device associated with the marketplace provider to execute the enrichment operation on the transaction data.

14. The computer-implemented method according to claim 9, wherein the method further includes:
receiving an initiating operation request message from the requestor; and
translating the initiating operation request message to generate the operation request message.

15. At least one non-transitory computer-readable storage medium that includes computer-executable instructions embodied thereon that when the computer-executable instructions are executed by at least one processor of a marketplace operation computer, the computer-executable instructions cause the at least one processor to:
receive a payment transaction message including one or more identifiers;
query a marketplace registration database using the one or more identifiers contained in the payment transaction message to retrieve a registration record, wherein the registration record includes an identification of at least one of a marketplace provider and an enrichment operation;
generate an operation request message based on the identified at least one marketplace provider and enrichment operation;
transmit at least a portion of the operation request message to the identified marketplace provider;
in response to the transmission, receive an operation result message from the identified marketplace provider including an output result of the enrichment operation being applied to the payment transaction message; and
transmit, to a requestor computer system, a response message indicating the output result of the enrichment operation being applied to the payment transaction message.

16. The non-transitory computer-readable storage medium according to claim 15, wherein the marketplace operation request message includes instructions executable to cause said at least one processor to:
transmit the operation request message via a gateway for an application programming interface (API), the API defining a plurality of parameters corresponding to a plurality of data fields of a communications standard for exchange of financial transaction data between financial institutions.

17. The non-transitory computer-readable storage medium according to claim 15, wherein the requestor is an in-network party associated with a processing network where the payment transaction message was initiated, the in-network party including at least one of a cardholder who initiates the payment transaction, a merchant at which the payment transaction was initiated, an issuer associated with the cardholder, and an acquirer associated with the merchant.

18. The non-transitory computer-readable storage medium according to claim 15, wherein marketplace providers do not include an issuer, a merchant, and an acquirer, and wherein the marketplace providers include computing devices hosted on a separate off-network system.

19. The non-transitory computer-readable storage medium according to claim 15, wherein the marketplace operation request includes instructions executable to cause said at least one processor to:
generate the operation request message based on the identified at least one marketplace provider and enrichment operation, wherein the operation request message is formatted according to a communications standard for exchange of financial transaction data between financial institutions, the communications standard defining a plurality of data fields to be included within messages compliant with the communications standard, and wherein the operation request message is configured to cause a computing device associated with the marketplace provider to execute the enrichment operation on the transaction data.

20. The non-transitory computer-readable storage medium according to claim 15, wherein the processor is further configured to:
receive an initiating operation request message from the requestor; and
translate the initiating operation request message to generate the operation request message.
